(19) United States
(12) Patent Application Publication
(10) Pub. No.: US 2008/0092156 A1
(43) Pub. Date: Apr. 17, 2008

(54) Systems and methods for automatically identifying a user profile

(75) Inventor: Andrew Ferrone, Boston, MA (US)

Correspondence Address: ROPES & GRAY LLP, PATENT DOCKETING 39/361, 1211 AVENUE OF THE AMERICAS, NEW YORK, NY, 10036-8704, US

(73) Assignee: United Video Properties, Inc., Los Angeles, CA (US)

(21) Appl. No.: 11/600,954

(22) Filed: Nov. 15, 2006

Related U.S. Application Data
(60) Provisional application No. 60/848,600, filed on Sep. 29, 2006.

(51) Int. Cl. H04N 5/445; H04H 9/00; G06F 3/00; H04H 60/32; H04H 60/33; G06F 13/00; H04N 7/16

(52) U.S. Cl. 725/13; 725/9; 725/14; 725/46

(57) ABSTRACT

Systems and methods for automatically recognizing a user of an interactive media guidance application are provided. The interactive media guidance application may monitor a plurality of users' interactions with the interactive media guidance application, and determine, from the interactions, user profiles. For example, the interactive media guidance application may determine that a number of interactions (e.g., a number of viewed programs) satisfy a relevancy rule, and associate the interactions with the same user profile. The interactive media guidance application may identify the parts of the day when each user uses the interactive media guidance application, and associate the corresponding user profiles with the current day part. The interactive media guidance application may further identify the user that is associated with each user profile by prompting a user to identify himself during the day part that is associated with a particular user profile.

### PRIORITY CLAIM

This application claims the benefit of U.S. Provisional Patent Application No. 60/848,600, filed Sep. 29, 2006.

### BACKGROUND OF THE INVENTION

This invention is directed to systems and methods for automatically identifying a user profile of an interactive media system.

Interactive media guidance applications, such as interactive television program guides, are well known in the art. Using an interactive media guidance application, users may access and organize enormous amounts of information and content. To assist the user in quickly finding content that matches the user's interests, the interactive media guidance application may determine the user's interests, and identify content that corresponds to the determined interests. Then, when the interactive media guidance application identifies a user that is currently using the user's equipment, the interactive media guidance application may display content and information that is most likely to be of interest to the user (e.g. in the form of recommendations for programs of interest to the user).

Many existing interactive media guidance applications require users to affirmatively perform an action to identify the current user. For example, the interactive media guidance application may require a user to log in. As another example, the interactive media guidance application may identify the user in response to the user entering unique information (e.g., the user enters a personal code for ordering on-demand content). Although requiring users to affirmatively identify themselves may be relatively reliable, it may also be time-consuming, troublesome, or both.

It would be desirable, therefore, for the interactive media guidance application to automatically identify the current user or the user profile of the current user. In addition, it would be desirable to provide systems and methods for associating parts of each day with particular users or user profiles.

### SUMMARY OF THE INVENTION

In accordance with the principles of the present invention, systems and methods for automatically identify the current user or the user profile of the current user are provided. In addition, systems and methods for associating parts of each day with particular users or user profiles are also provided.

In some embodiments, the interactive media guidance application may monitor user interactions with the interactive media guidance application at different times of day. The interactions may include the media or content that is viewed, the interactive media guidance application functions that are accessed, or any other user interactions. The interactive media guidance application may compare the interactions to identify the interactions that are associated with each user. For example, the interactive media guidance application may use a relevancy rule or edge detection-type algorithm to determine how similar two or more interactions are. If the two or more interactions satisfy the relevancy rule (e.g., are similar enough), the interactive media guidance application may conclude that the interactions are associated with the same user.

The interactive media guidance application may create one or more user profiles for each set of interactions that the interactive media guidance application identifies as being associated with each user. The user profiles may include the monitored user interactions, metadata related to the interactions (e.g., genre, actor, or channel information), or any other information on the user's interests that can be deduced from the monitored interactions. The interactive media guidance application may store the user profiles in memory for future use.

The interactive media guidance application may also determine, from the monitored user interactions and user profiles, the times or parts of day when the user of each user profile uses the user equipment. The interactive media guidance application may associate, with each day part, the corresponding user profile. The interactive media guidance application may then automatically identify the user profile of the current user by identifying the user profile associated with the current day part.

The interactive media guidance application may also associate specific users with each day part. For example, the interactive media guidance application may prompt a user to identify himself during a day part, and associate the identified user with the user profile of the day part. As another example, the interactive media guidance application may identify the user when the user logs into the system (e.g., to purchase an on-demand program).

Once the interactive media guidance application has identified the current user profile or user, the interactive media guidance application may provide personalized media, content, or interactive media guidance application features that are targeted to the current user or user profile. For example, the interactive media guidance application may display a personalized user interface, targeted advertisements, or any other suitable media, content, or interactive media guidance application feature. The interactive media guidance application may also determine demographic information for each user by comparing the interests identified in each user profile with a library of preferences that are associated with demographic information.

### BRIEF DESCRIPTION OF THE DRAWINGS

FIG. 1 shows an illustrative interactive media guidance application display screen in accordance with the principles of the present invention;

FIG. 2 shows another illustrative interactive media guidance application display screen in accordance with the principles of the present invention;

FIG. 3 is a diagram of illustrative user equipment in accordance with the principles of the present invention;

FIG. 4 is a diagram of an illustrative media system in accordance with the principles of the present invention;

FIG. 5 shows an illustrative data structure for storing metadata for media in accordance with the principles of the present invention;

FIG. 6 shows an illustrative display screen for identifying a user in accordance with the principles of the present invention;

FIG. 7 shows another illustrative display screen for identifying a user in accordance with the principles of the present invention; and

FIGS. 8 and 9 are illustrative flow charts of processes for associating user profiles with day parts in accordance with the principles of the present invention.

### DETAILED DESCRIPTION

The amount of media available to users in any given media delivery system can be substantial. Consequently, many users desire a form of media guidance through an interface that allows users to efficiently navigate media selections and easily identify media that they may desire. An application which provides such guidance is referred to herein as an interactive media guidance application or, sometimes, a media guidance application or a guidance application.

Interactive media guidance applications may take various forms depending on the media for which they provide guidance. One typical type of media guidance application is an interactive television program guide. Interactive television program guides (sometimes referred to as electronic program guides) are well-known guidance applications that, among other things, allow users to navigate among and locate many types of media content including conventional television programming (provided via traditional broadcast, cable, satellite, Internet, or other means), as well as pay-per-view programs, on-demand programs (as in video-on-demand (VOD) systems), Internet content (e.g., streaming media, downloadable media, Webcasts, etc.), and other types of media or video content. Guidance applications also allow users to navigate among and locate content related to the video content including, for example, video clips, articles, advertisements, chat sessions, games, etc.

With the advent of the Internet, mobile computing, and high-speed wireless networks, users are accessing media on personal computers (PCs) and other devices on which they traditionally did not, such as hand-held computers, personal digital assistants (PDAs), mobile telephones, or other mobile devices. On these devices users are able to navigate among and locate the same media available through a television. Consequently, media guidance is necessary on these devices, as well. The guidance provided may be for media content available only through a television, for media content available only through one or more of these devices, or for media content available both through a television and one or more of these devices. The media guidance applications may be provided as online applications (i.e., provided on a web-site), or as stand-alone applications or clients on hand-held computers, PDAs, mobile telephones, or other mobile devices. The various devices and platforms that may implement media guidance applications are described in more detail below.

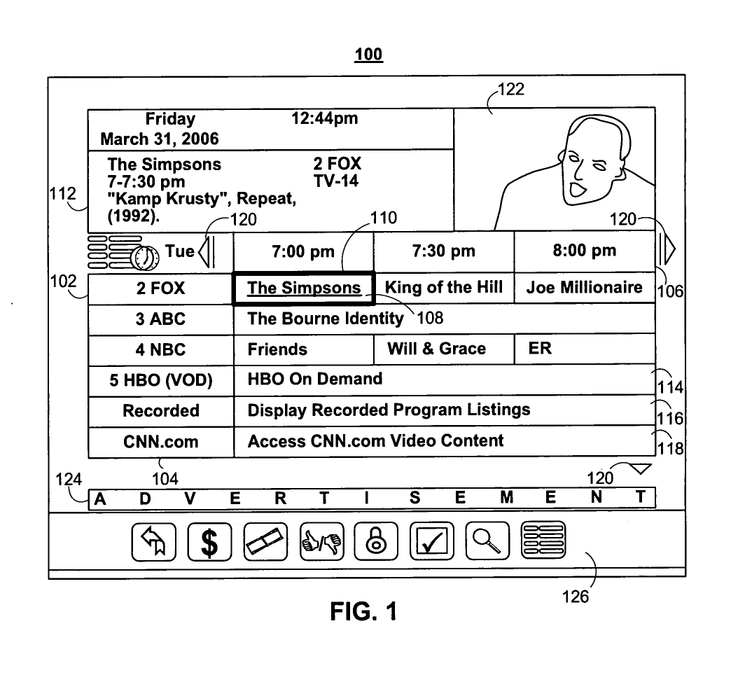

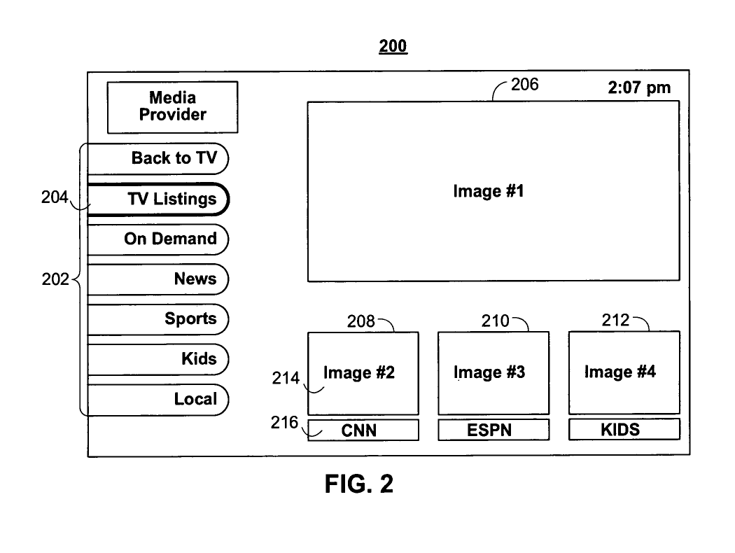

One of the functions of the media guidance application is to provide media listings and media information to users. FIGS. 1-2 show illustrative display screens that may be used to provide media guidance, and in particular media listings. The display screens shown in FIGS. 1-2 and 6-7 may be implemented on any suitable device or platform. While the displays of FIGS. 1-2 and 6-7 are illustrated as full screen displays, they may also be fully or partially overlaid over media content being displayed. A user may indicate a desire to access media information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media information organized in one of several ways, such as by time and channel in a grid, by time, by channel, by media type, by category (e.g., movies, sports, news, children, or other categories of programming), or other predefined, user-defined, or other organization criteria.

FIG. 1 shows illustrative grid program listings display 100 arranged by time and channel that also enables access to different types of media content in a single display. Display 100 may include grid 102 with: (1) a column of channel/media type identifiers 104, where each channel/media type identifier (which is a cell in the column) identifies a different channel or media type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming provided according to a schedule, the media guidance application also provides access to non-linear programming which is not provided according to a schedule. Non-linear programming may include content from different media sources including on-demand media content (e.g., VOD), Internet content (e.g., streaming media, downloadable media, etc.), locally stored media content (e.g., video content stored on a digital video recorder (DVR), digital video disc (DVD), video cassette, compact disc (CD), etc.), or other time-insensitive media content. On-demand content may include both movies and original media content provided by a particular media provider (e.g., HBO On Demand providing “The Sopranos” and “Curb Your Enthusiasm”). HBO ON DEMAND, THE SOPRANOS, and CURB YOUR ENTHUSIASM are trademarks owned by the Home Box Office, Inc. Internet content may include web events, such as a chat session or Webcast, or content available on-demand as streaming media or downloadable media through an Internet web site or other Internet access (e.g. FTP).

Grid 102 may provide listings for non-linear programming including on-demand listing 114, recorded media listing 116, and Internet content listing 118. A display combining listings for content from different types of media sources is sometimes referred to as a “mixed-media” display. The various permutations of the types of listings that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In other embodiments, listings for these media types may be included directly in grid 102. Additional listings may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the present invention.

Advertisement 124 may provide an advertisement for media content that, depending on a viewer's access rights (e.g., for subscription programming), is currently available for viewing, will be available for viewing in the future, or may never become available for viewing, and may correspond to or be unrelated to one or more of the media listings in grid 102. Advertisement 124 may also be for products or services related or unrelated to the media content displayed in grid 102. Advertisement 124 may be selectable and provide further information about media content, provide information about a product or a service, enable purchasing of media content, a product, or a service, provide media content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over media content or a guidance application display or embedded within a display. Advertisements may also include text, images, rotating images, video clips, or other types of media content. Advertisements may be stored in the user equipment with the guidance application, in a database connected to the user equipment, in a remote location (including streaming media servers), or on other storage means or a combination of these locations. Providing advertisements in a media guidance application is discussed in greater detail in, for example, Knudson et al., U.S. patent application Ser. No. 10/347,673, filed Jan. 17, 2003, Ward, III et al. U.S. Pat. No. 6,756,997, issued Jun. 29, 2004 and Schein et al. U.S. Pat. No. 6,388,714, issued May 14, 2002, which are hereby incorporated by reference herein in their entireties. It will be appreciated that advertisements may be included in other media guidance application display screens of the present invention.

Options region 126 may allow the user to access different types of media content, media guidance application displays, and/or media guidance application features. Options region 126 may be part of display 100 (and other display screens of the present invention), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, access to various types of listing displays, subscribe to a premium service, edit a user's profile, access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of media content listings displayed (e.g., only HDTV programming, user-specified broadcast channels based on favorite channel selections, re-ordering the display of channels, recommended media content, etc.), desired recording features (e.g., recording or series recordings for particular users, recording quality, etc.), parental control settings, and other desired customizations.

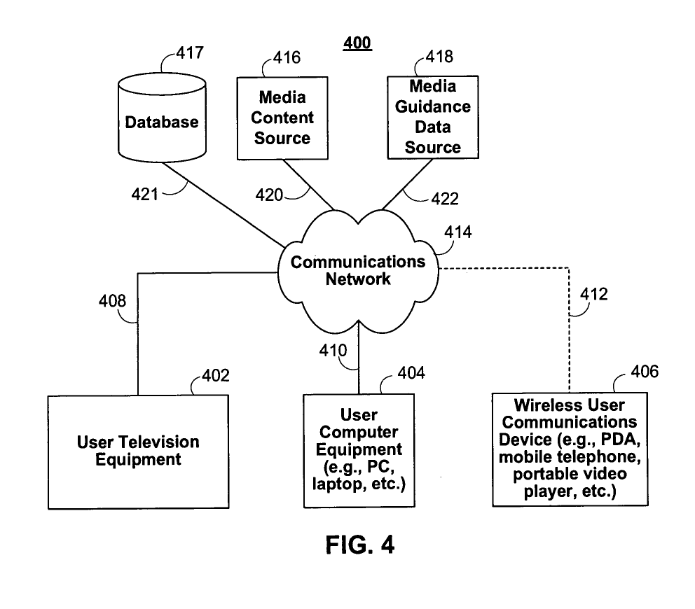

The media guidance application may allow a user to provide user profile information or may automatically compile user profile information. The media guidance application may, for example, monitor the media the user accesses and/or other interactions the user may have with the guidance application. Additionally, the media guidance application may obtain all or part of other user profiles that are related to a particular user (e.g., from other web sites on the Internet the user accesses, such as www.tvguide.com, from other media guidance applications the user accesses, from other interactive applications the user accesses, from a handheld device of the user, etc.), and/or obtain information about the user from other sources that the media guidance application may access. As a result, a user can be provided with a unified guidance application experience across the user's different devices. This type of user experience is described in greater detail below in connection with FIG. 4. Additional personalized media guidance application features are described in greater detail in Ellis et al., U.S. patent application Ser. No. 11/179,410, filed Jul. 11, 2005, Boyer et al., U.S. patent application Ser. No. 09/437,304, filed Nov. 9, 1999, and Ellis et al., U.S. patent application Ser. No. 10/105,128, filed Feb. 21, 2002, which are hereby incorporated by reference herein in their entireties.

Another display arrangement for providing media guidance is shown in FIG. 2. Video mosaic display 200 includes selectable options 202 for media content information organized based on media type, genre, and/or other organization criteria. In display 200, television listings option 204 is selected, thus providing listings 206, 208, 210, and 212 as broadcast program listings. Unlike the listings from FIG. 1, the listings in display 200 are not limited to simple text (e.g., the program title) and icons to describe media. Rather, in display 200 the listings may provide graphical images including cover art, still images from the media content, video clip previews, live video from the media content, or other types of media that indicates to a user the media content being described by the listing. Each of the graphical listings may also be accompanied by text to provide further information about the media content associated with the listing. For example, listing 208 may include more than one portion, including media portion 214 and text portion 216. Media portion 214 and/or text portion 216 may be selectable to view video in full-screen or to view program listings related to the video displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the media provider or based on user preferences. Various systems and methods for graphically accentuating media listings are discussed in, for example, Yates, U.S. patent application Ser. No. 11/324,202, filed Dec. 29, 2005, which is hereby incorporated by reference herein in its entirety.

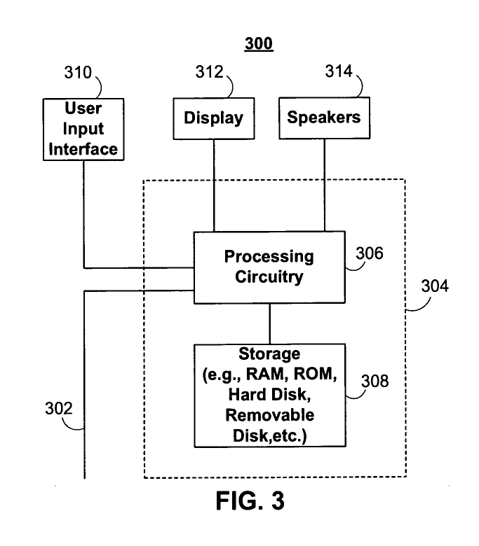

Users may access media content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive media content and data via input/output (hereinafter “I/O”) path 302. I/O path 302 may provide media content (e.g., broadcast programming, on-demand programming, Internet content, and other video or audio) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry 306 such as processing circuitry based on one or more microprocessors, microcontrollers, digital signal processors, programmable logic devices, etc. In some embodiments, control circuitry 304 executes instructions for a media guidance application stored in memory (i.e., storage 308). In client-server based embodiments, control circuitry 304 may include communications circuitry suitable for communicating with a guidance application server or other networks or servers. Communications circuitry may include a cable modem, an integrated services digital network (ISDN) modem, a digital subscriber line (DSL) modem, a telephone modem, or a wireless modem for communications with other equipment. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory (e.g., random-access memory, read-only memory, or any other suitable memory), hard drives, optical drives, or any other suitable fixed or removable storage devices (e.g., DVD recorder, CD recorder, video cassette recorder, or other suitable recording device) may be provided as storage 308 that is part of control circuitry 304. Storage 308 may include one or more of the above types of storage devices. For example, user equipment device 300 may include a hard drive for a DVR (sometimes called a personal video recorder, or PVR) and a DVD recorder as a secondary storage device. Storage 308 may be used to store various types of media described herein and guidance application data, including program information, guidance application settings, user preferences or profile information, or other data used in operating the guidance application. Nonvolatile memory may also be used (e.g., to launch a boot-up routine and other instructions).

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits may also be included as part of circuitry 304. Encoding circuitry (e.g., for converting over-the-air, analog, or digital signals to MPEG signals for storage) may also be provided. Control circuitry 304 may also include scaler circuitry for upconverting and downconverting media into the preferred output format of the user equipment 300. Circuitry 304 may also include digital-to-analog converter circuitry and analog-to-digital converter circuitry for converting between digital and analog signals. The tuning and encoding circuitry may be used by the user equipment to receive and to display, to play, or to record media content. The tuning and encoding circuitry may also be used to receive guidance data. The circuitry described herein, including for example, the tuning, video generating, encoding, decoding, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may control the control circuitry 304 using user input interface 310. User input interface 310 may be any suitable user interface, such as a remote control, mouse, trackball, keypad, keyboard, touch screen, touch pad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. Speakers 314 may be provided as integrated with other elements of user equipment device 300 or may be stand-alone units. The audio component of videos and other media content displayed on display 312 may be played through speakers 314. In some embodiments, the audio may be distributed to a receiver (not shown), which processes and outputs the audio via speakers 314.

User equipment device 300 of FIG. 3 can be implemented in system 400 of FIG. 4 as user television equipment 402, user computer equipment 404, wireless user communications device 406, or any other type of user equipment suitable for accessing media, such as a non-portable gaming machine. For simplicity, these devices may be referred to herein collectively as user equipment or user equipment devices. User equipment devices, on which a media guidance application is implemented, may function as a standalone device or may be part of a network of devices. Various network configurations of devices may be implemented and are discussed in more detail below.

User television equipment 402 may include a set-top box, an integrated receiver decoder (IRD) for handling satellite television, a television set, a digital storage device, a DVD recorder, a video-cassette recorder (VCR), a local media server, or other user television equipment. One or more of these devices may be integrated to be a single device, if desired. User computer equipment 404 may include a PC, a laptop, a tablet, a WebTV box, a personal computer television (PC/TV), a PC media server, a PC media center, or other user computer equipment. WEBTV is a trademark owned by Microsoft Corp. Wireless user communications device 406 may include PDAs, a mobile telephone, a portable video player, a portable music player, a portable gaming machine, or other wireless devices.

It should be noted that with the advent of television tuner cards for PC's, WebTV, and the integration of video into other user equipment devices, the lines have become blurred when trying to classify a device as one of the above devices. In fact, each of user television equipment 402, user computer equipment 404, and wireless user communications device 406 may utilize at least some of the system features described above in connection with FIG. 3 and, as a result, include flexibility with respect to the type of media content available on the device. For example, user television equipment 402 may be Internet-enabled allowing for access to Internet content, while user computer equipment 404 may include a tuner allowing for access to television programming. The media guidance application may also have the same layout on the various different types of user equipment or may be tailored to the display capabilities of the user equipment. For example, on user computer equipment, the guidance application may be provided as a web site accessed by a web browser. In another example, the guidance application may be scaled down for wireless user communications devices.

In system 400, there is typically more than one of each type of user equipment device but only one of each is shown in FIG. 4 to avoid overcomplicating the drawing. In addition, each user may utilize more than one type of user equipment device (e.g., a user may have a television set and a computer) and also more than one of each type of user equipment device (e.g., a user may have a PDA and a mobile telephone and/or multiple television sets).

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.tvguide.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile device (e.g., Blackberry) network, cable network, public switched telephone network, or other types of communications network or combinations of communications networks. BLACKBERRY is a trademark owned by Research In Motion Limited Corp. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 that it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a trademark owned by Bluetooth SIG, INC. The user equipment devices may also communicate with each other directly through an indirect path via communications network 414.

System 400 includes media content source 416, database 417, and media guidance data source 418 coupled to communications network 414 via communication paths 420, 421 and 422, respectively. Paths 420, 421 and 422 may include any of the communication paths described above in connection with paths 408, 410, and 412. Communications with the media content source 416, database 417, and media guidance data source 418 may be exchanged over one or more communications paths, but are shown as a single path in FIG. 4 to avoid overcomplicating the drawing. In addition, there may be more than one of each of media content source 416, database 417, and media guidance data source 418, but only one of each is shown in FIG. 4 to avoid overcomplicating the drawing. (The different types of each of these sources are discussed below.) If desired, two or more of media content source 416, database 417, and media guidance data source 418 may be integrated as one source device. Although communications between sources 416 and 418 and database 417 with user equipment devices 402, 404, and 406 are shown as through communications network 414, in some embodiments, sources 416 and 418 and database 417 may communicate directly with user equipment devices 402, 404, and 406 via communication paths (not shown) such as those described above in connection with paths 408, 410, and 412.

Media content source 416 may include one or more types of media distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other media content providers. NBC is a trademark owned by the National Broadcasting Company, Inc., ABC is a trademark owned by the ABC, INC., and HBO is a trademark owned by the Home Box Office, Inc. Media content source 416 may be the originator of media content (e.g., a television broadcaster, a Webcast provider, etc.) or may not be the originator of media content (e.g., an on-demand media content provider, an Internet provider of video content of broadcast programs for downloading, etc.). Media content source 416 may include cable sources, satellite providers, on-demand providers, Internet providers, or other providers of media content. Media content source 416 may also include a remote media server used to store different types of media content (including video content selected by a user), in a location remote from any of the user equipment devices. Systems and methods for remote storage of media content, and providing remotely stored media content to user equipment are discussed in greater detail in connection with Ellis et al., U.S. patent appliation Ser. No. 09/332,244, filed Jun. 11, 1999, which is hereby incorporated by reference herein in its entirety.

Media guidance data source 418 may provide media guidance data, such as media listings, media-related information (e.g., broadcast times, broadcast channels, media titles, media descriptions, ratings information (e.g., parental control ratings, critic's ratings, etc.), genre or category information, actor information, logo data for broadcasters' or providers' logos, etc.), media format (e.g., standard definition, high definition, etc.), advertisement information (e.g., text, images, media clips, etc.), on-demand information, and any other type of guidance data that is helpful for a user to navigate among and locate desired media selections.

Media guidance application data may be provided to the user equipment devices using any suitable approach. In some embodiments, the guidance application may be a stand-alone interactive television program guide that receives program guide data via a data feed (e.g., a continuous feed, trickle feed, or data in the vertical blanking interval of a channel). Program schedule data and other guidance data may be provided to the user equipment on a television channel sideband, in the vertical blanking interval of a television channel, using an in-band digital signal, using an out-of-band digital signal, or by any other suitable data transmission technique. Program schedule data and other guidance data may be provided to user equipment on multiple analog or digital television channels. Program schedule data and other guidance data may be provided to the user equipment with any suitable frequency (e.g., continuously, daily, a user-specified period of time, a system-specified period of time, in response to a request from user equipment, etc.). In some approaches, guidance data from media guidance data source 418 may be provided to users' equipment using a client-server approach. For example, a guidance application client residing on the user's equipment may initiate sessions with source 418 to obtain guidance data when needed. Media guidance data source 418 may provide user equipment devices 402, 404, and 406 the media guidance application itself or software updates for the media guidance application.

Media guidance applications may be, for example, stand-alone applications implemented on user equipment devices. In other embodiments, media guidance applications may be client-server applications where only the client resides on the user equipment device. For example, media guidance applications may be implemented partially as a client application on control circuitry 304 of user equipment device 300 and partially on a remote server as a server application (e.g., media guidance data source 418). The guidance application displays may be generated by the media guidance data source 418 and transmitted to the user equipment devices. The media guidance data source 418 may also transmit data for storage on the user equipment, which then generates the guidance application displays based on instructions processed by control circuitry.

Database 417 may be used to store metadata related to media or content (e.g., television programs). Database 417 may be populated using data provided by media guidance data source 418, data provided by media content source 416, data entered by an operator, or any suitable combination thereof. The metadata may describe various properties of the media, for example genre (e.g., sports, news, talk show), title, description, channel, actors, or any other suitable property of media, and be stored as metadata values for each property.

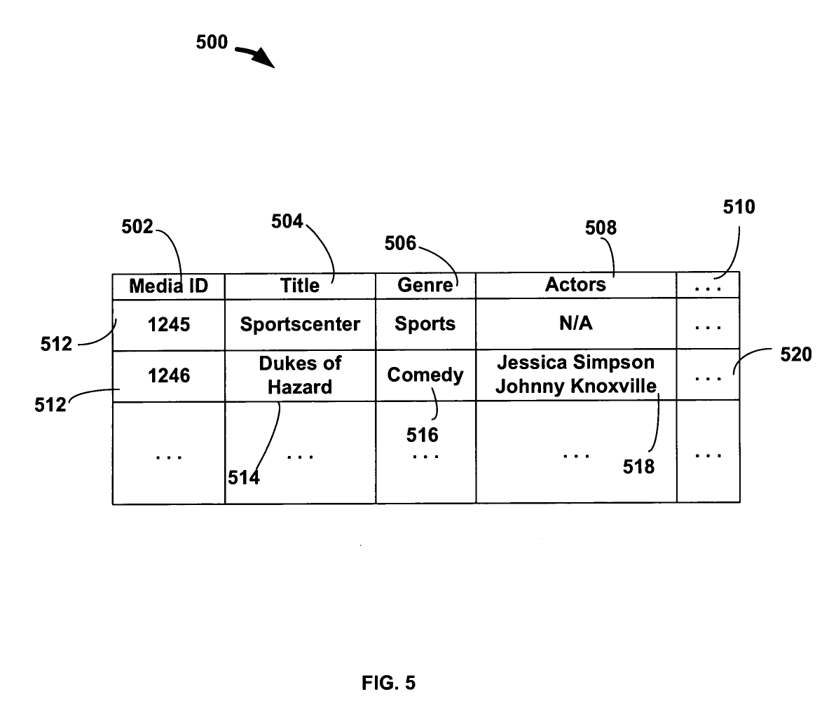

Database 417 may store the metadata using any suitable data structure. FIG. 5 shows illustrative data structure 500 for storing metadata. Data structure 500 includes column 502 for media identifiers, and columns 504, 506, 508 and 510 of metadata. In the data structure shown in FIG. 5, data structure 500 includes columns 504, 506 and 508, respectively, for the title, genre and actors of each program, though any suitable combination of metadata properties may be used in the data structure. Each instance of media (e.g., each television program) is identified in a row of column 502 by a unique identifier 512. In the row, associated with the unique identifier, data structure 500 includes metadata values 514, 516, 518 and 520 for each of the metadata properties identified in columns 504, 506, 508 and 510, respectively.

Each media may be identified in database 417 by a unique program identifier.

Database 417 may be configured to store user profiles. The user profile may include each user's preferences, media that the user views, interactive media guidance application functions that the user accesses, or any other suitable information. The user's preferences may be stored as lists or tables of metadata values. For example, the user profile may include the metadata values for each program that the user views (e.g., genre, actor, and channel). The interactive media guidance application may weigh each metadata value based on how often the user accesses media with that metadata value (e.g., the user profile indicates that a user likes 60% comedy, 40% sports). In some embodiments, the interactive media guidance application may store a user profile for each user.

In some embodiments, storage 308 (FIG. 3) may be used to store the information stored in database 417. For example, using control circuitry 304 (FIG. 3), the interactive media guidance application may direct storage 308 to store user profiles, metadata related to media, or both.

Media guidance system 400 is intended to illustrate a number of approaches, or network configurations, by which user equipment devices and sources of media content and guidance data may communicate with each other for the purpose of accessing media and providing media guidance. The present invention may be applied in any one or a subset of these approaches, or in a system employing other approaches for delivering media and providing media guidance. The following three approaches provide specific illustrations of the generalized example of FIG. 4.

In one approach, user equipment devices may communicate with each other within a home network. User equipment devices can communicate with each other directly via short-range point-to-point communication schemes describe above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit media content. For example, a user may transmit media content from user computer equipment to a portable video player or portable music player.

In a second approach, users may have multiple types of user equipment by which they access media content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. patent application Ser. No. 10/927,814, filed Aug. 26, 2004, which is hereby incorporated by reference herein in its entirety.

In a third approach, users of user equipment devices inside and outside a home can use their media guidance application to communicate directly with media content source 416 to access media content. Specifically, within a home, users of user television equipment 404 and user computer equipment 406 may access the media guidance application to navigate among and locate desirable media content. Users may also access the media guidance application outside of the home using wireless user communications devices 406 to navigate among and locate desirable media content.

It will be appreciated that while the discussion of media content has focused on video content, the principles of media guidance can be applied to other types of media content, such as music, images, etc.

In accordance with the principles of the present invention, the interactive media guidance application may automatically identify a user or user profile. Before the interactive media guidance application can automatically identify a user, the interactive media guidance application may need to determine each user's preferences. To do this, the interactive media guidance application may monitor the users' interactions with the interactive media system, and identify user profiles based on the monitored interactions.

The interactive media guidance application may use any suitable approach to monitor the users' interactions with the interactive system (e.g., interactive system 400). For example, the interactive media guidance application may include an application that logs every time the user equipment is turned on, turned off, which content is accessed (e.g., which television programs are watched, recorded, or selected as favorites), and which interactive media guidance application features are displayed. The interactive media guidance application may also log metadata related to the content that is accessed (e.g., genre of an on-demand program that a user watches) or interactive media guidance application features that are displayed (e.g., settings selected when configuring a reminder feature). The interactive media guidance application may store the logs of monitored user interactions in any suitable manner. For example, control circuitry 304 (FIG. 3) may direct storage 308 (FIG. 3) to store the logs with the monitored user interactions. As another example, control circuitry 304 may direct database 417 (FIG. 4) to store the logs.

Once the interactive media guidance application has logged the users' interactions, the interactive media guidance application may identify specific user profiles from the interactions. For example, the interactive media guidance application may use metadata associated with content that is accessed (e.g., genre, title, description, actors) and metadata that is associated with interactive media guidance application features that are displayed (e.g., news information, sports scores, recommended programs that are selected) to identify interactions that appear to be related to the same user. More specifically, control circuitry 304 may retrieve logs stored in storage 308 or database 417, and analyze the metadata to identify patterns or interactions that satisfy some criteria.

The interactive media guidance application may use any suitable approach to determine which interactions to associate with a particular user profile. For example, the interactive media guidance application may use a relevancy rule or an edge detection-type algorithm to compare metadata associated with the user interactions, and select particular interactions that satisfy the rule (e.g., are similar enough) for a particular user profile. For example, the interactive media guidance application may determine that a broadcast episode of “Law and Order” and an on-demand episode of “CSI: New York” are both episodes of television series that relate to detective work in New York City, both broadcast in primetime, and both targeted to adults. Using the appropriate rule or algorithm, the interactive media guidance application may determine that these two programs are similar, and should therefore be associated with the same user profile. As another example, the interactive media guidance application may determine that “Little Einsteins” is different than “Law and Order” because “Little Einsteins” is a cartoon, is shown in the morning or early afternoon, and is targeted to children. Because the metadata associated with “Law and Order” and with “Little Einsteins” are substantially different, the metadata for these media do not satisfy the relevancy rule or edge detection-type algorithm. Accordingly, the user interaction related to “Little Einsteins” is associated with a different user profile.

The relevancy rule may be any suitable rule for determining the similarity between media or interactive media guidance application functions. In some embodiments, the relevancy rule may be based on a minimum aggregate relational distance between the media or interactive media guidance application functions, where the aggregate relational distance is a measure of the similarity between media or interactive media guidance application functions. The interactive media guidance application may calculate the aggregate relational distance in any suitable manner. For example, the interactive media guidance application may perform a distance calculation based on the metadata associated with each media or interactive media guidance application function (e.g., the distance between two programs with the same or similar genres is smaller than the distance between two programs with substantially different genres). In some embodiments, the interactive media guidance application may use an edge detection-type algorithm to determine the similarity between media or interactive media guidance application functions. If the result of the edge detection-type algorithm satisfies a similarity threshold, the interactive media guidance application may associate the media or interactive media guidance application function with the same user profile.

The interactive media guidance application may store the user profiles in any suitable device of interactive system 100. For example, the interactive media guidance application may direct control circuitry 304 (FIG. 3) to store a user profile in storage 308 (FIG. 3). As another example, the interactive media guidance application may direct control circuitry 304 to store a user profile in database 417 (FIG. 4).

Once the interactive media guidance application has identified user profiles based on the logged user interactions, the interactive media guidance application may compare the profiles with days and times of days at which the user equipment was turned on (e.g., based on logged information stored in storage 308). The interactive media guidance application may then associate particular user profiles with the days and times of day (e.g., day parts) at which the user of the particular user profile used the user equipment (e.g., associate weekdays, 2-3 PM with the user profile that is associated with cartoons and that watches cartoons from 2-3 on Wednesdays). The interactive media guidance application may store the associations of day parts with user profiles in memory. For example, control circuitry 304 may store the associations of day parts with user profiles in storage 308.

More generally, the interactive media guidance application may associate day parts with user profiles by associating the day part of each interaction with the user profile of the interaction. The interactive media guidance application may further associate day parts during which there were no monitored user interactions with particular user profiles based on the day parts that have already been associated. For example, the interactive media guidance application may associate Monday mornings from 7-8 AM with a first user profile. The user of the first user profile watches news shows from 7-8 AM. Because watching morning news may be a routine, the interactive media guidance application may automatically associate every morning from 7-8 AM with the first user profile, even though the interactive media guidance application may not have monitored a user interaction one morning (e.g., because the user was away on a business trip that morning).

In some embodiments, the interactive media guidance application may apply the same partitioning to a number of days of the week (e.g., apply the same partitioning from Monday through Friday). In some embodiments, however, the interactive media guidance application may partition each day separately to attempt to predict unusual viewing patterns for some users. For example, the interactive media guidance application may determine, based on a user profile, that a user does not miss a Yankees game, which are typically at 7 PM. The interactive media guidance application then associates the 7-10 PM time each evening with the corresponding user profile. If the interactive media guidance application determines, for example from interactive media guidance application data provided by data source 418 (FIG. 4), that the Yankees play a game from 1-4 PM on Thursday, the interactive media guidance application may associate the 1-4 PM time on Thursday with the user profile.

When the interactive media system includes a plurality of user devices that are simultaneously used, the interactive media guidance application may create distinct user profiles for the interactions of each user device. For example, in a household with two televisions, the interactive media guidance application may identify two interactions: a news show from 7-8 AM every morning, and a sports show from 7-8 AM every morning. In response to these two simultaneous interactions, the interactive media guidance application may create a first user profile for the first interaction, and a second user profile for the second interaction. The interactive media guidance application may also associate both profiles with the 7-8 AM day part, and determine which user profile applies to each user device based on the program watched during the day part (e.g., if a sports program is displayed in the living room television and a news program is displayed in the bedroom television, the interactive media guidance application may determine that the first user profile is currently associated with the bedroom television, and the second user profile is currently associated with the living room television).

Having associated user profiles to a number of day parts, the interactive media guidance application may seek to associate particular users with each user profile. The interactive media guidance application may use any suitable approach to identify particular users and their user profiles. In some embodiments, if a user has provided his preferences (e.g., in response to prompts from the interactive media guidance application), the interactive media guidance application may compare the preferences with each user profile, and identify the user profile that has media and interactions that most closely match the user's preferences (e.g., based on the metadata associated with the interactions using a relevancy rule or an edge detection-type algorithm).

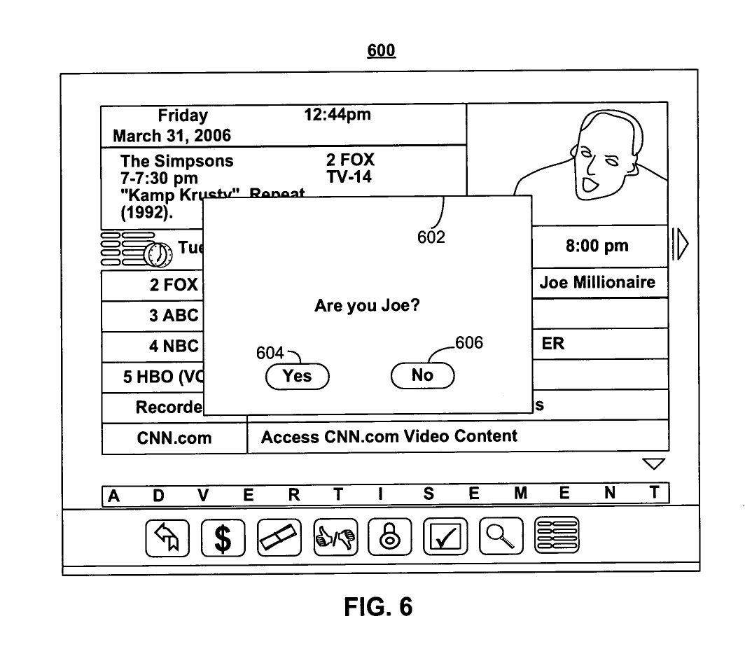

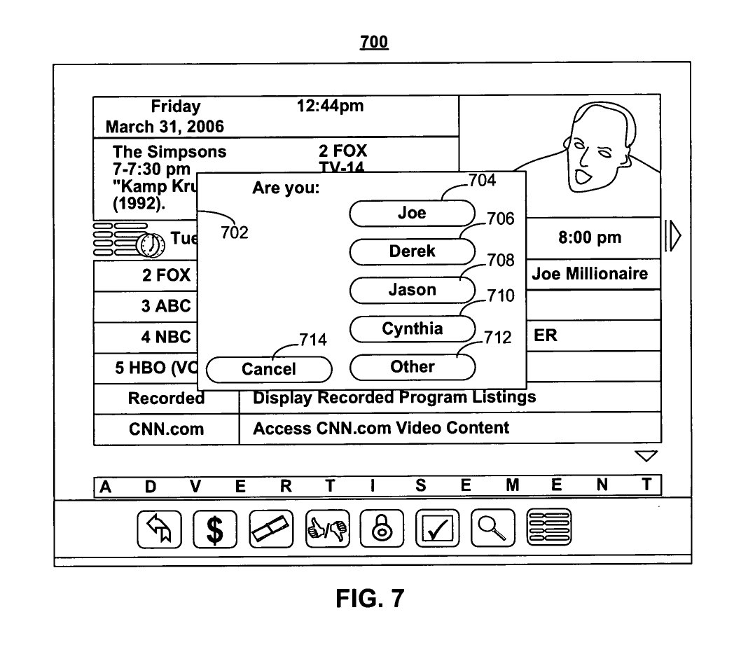

The interactive media guidance application may confirm that it has properly associated a user with a profile by asking the user in a simple pop-up or other screen (e.g., are you Joe?). FIG. 6 shows illustrative display screen 600 for confirming the identify of a user. Screen 600 includes pop-up window 602. The pop-up window prompts the user to confirm or deny his identity (e.g., “Are you Joe?”). The user may confirm his identity by selecting “Yes” option 604, and indicate that he is not the identified user by selecting “No” option 606. If the user selects “No” option 606, the interactive media guidance application may display further prompts for the user to identify himself (e.g., screen 700, FIG. 7, described below). The use of a pop-up window in screen 600 is merely illustrative, and it will be understood that any other suitable display or approach may be used to confirm a user's identity.

In some embodiments, the interactive media guidance application may identify the user from periodic interactions when the user identifies himself. For example, the interactive media guidance application may determine that a user is associated with the current user profile in response to the user entering a unique (e.g., user specific) ID or other information to access an interactive media guidance application function (e.g., an on-demand program). The interactive media guidance application may also confirm that it has properly identified the user (e.g., using a pop-up window such as that of screen 600, FIG. 6). As another example, the interactive media guidance application may prompt the user to identify himself by entering a name, or selecting a name from a list. FIG. 7 shows illustrative display screen 700 for selecting a user from a list of users. Screen 700 includes pop-up window 702. The pop-up window prompts the user to identify himself by selecting his name from the list of known users of the system. The interactive media guidance application may determine the known users of the system from an initial set up (e.g., when the users first identified themselves as they set up the interactive media guidance application), past interactions where users were required to identify themselves (e.g., a user identified himself to purchase a pay-per-view program, or to access a chat application), or any other suitable occasion for identifying users. Pop-up window 702 may include a selectable option for each identified user. In the example shown in FIG. 7, the user may select any of “Joe” option 704, “Derek” option 706, “Jason” option 708 and “Cynthia” option 710 to identify him or herself as one of these users. If the user is not identified in any of the options of the pop-up window, the user may select “Other” option 712.

In response to the user selecting “Other” option 712, the interactive media guidance application may prompt the user to enter identifying information (e.g., a name) for future use. For example, the interactive media guidance application may prompt the user to spell out his name using user input interface 310 (FIG. 3). If the user does not want to identify himself, or is an occasional user of the system and not one whose interactions should be monitored (e.g., a babysitter watching television one evening while babysitting), the user may select “Cancel” option 714. The use of a pop-up window in screen 700 is merely illustrative, and it will be understood that any other suitable display or approach may be used to confirm a user's identity.

In some embodiments, a user may have such diverse interests that the interactive media guidance application may create two user profiles for the same user. If a user identifies himself as the user associated with two user profiles, the interactive media guidance application may combine the user profiles and associate the combined user profile with the user (e.g., in storage 308 or database 417).

The following example will serve to illustrate this process. A television is turned on every weekday from 7-8:30 AM and the user watches a mixture of morning talk shows. The television is then turned on again from 2-5 PM. The user watches mainly soap operas from 2-3 PM and then cartoons from 3-5 PM. Using an edge detection-type algorithm or relevancy rule (e.g., which serves to determine how close two programs are to each other), the interactive media guidance application may determine that there is little relevancy between what is watched from 2-3 PM and what is watched from 3-5 PM. But, again using the edge detection-type algorithm or relevancy rule, the interactive media guidance application may determine that what is watched from 7-8:30 AM and what is watched from 2-3 PM is similar (e.g., because the aggregate relational distance between morning talk shows and soap operas is relatively small) and fits the same profile, for example profile A. The profile for the user who watches cartoons is profile B. The interactive media guidance application may further determine, from the monitored interactions, that on weekends the television is turned on from 7-10 AM and the user watches mainly cartoons. This viewing pattern has a high relevancy to the viewing pattern of profile B. Thus, by the end of the week, the interactive media guidance application may have identified two dominant user profiles that use this television—profile A that likes morning talk shows and soap operas, and profile B that likes cartoons.

Furthermore, suppose when the interactive media system was first set up, three user identities were created—Jim, Jane, and John. The interactive media guidance application may determine that Jane logs on at 8 AM Monday and 7:47 AM Wednesday. This creates a link between profile A and Jane—this might be a link with relatively low relevancy to start, but the link can be strengthened over time. Now the interactive media guidance application also has reason to believe that it is also Jane who watches television from 2-3 PM. The interactive media guidance application may confirm this by prompting the television user from 2-3 PM to answer the question “Are you Jane?” (e.g., using screen 600, FIG. 6). A simple one-click answer “yes” or “no” may immediately allow the interactive media guidance application to confirm that the 2-3 PM day part is also associated with user profile A and Jane, and may thus help to build a more relevant profile for Jane. In particular, this process may allow the interactive media guidance application to target Jane more effectively across different day parts even though Jane never logged in during the afternoon day part.

In some embodiments, the interactive media guidance application may receive or collect demographic information about the users of media or interactive media guidance application features. For example, the interactive media guidance application may store, for each user, a demographic profile. In some embodiments, the interactive media guidance application may ask for some users to volunteer demographic information (e.g., as part of an initial set-up) to prepare an initial demographic profile.

Using each user's demographic profile, the interactive media guidance application may assign to each content that the user accesses (e.g., to each program viewed by the user) metadata that reflects the user's demographic profile. For example, the interactive media guidance application may direct database 417 (FIG. 4) to add demographic information metadata for media that is associated with a user's profile based on the user's demographic information (e.g., if Joe is a 30-year-old male, living in Nebraska, when Joe watches “Law and Order,” the interactive media guidance application may add metadata for “Law and Order” that indicates that a 30-year-old male from the Midwest watches the program). By combining demographic information metadata from a number of users, from a plurality of households across one or more geographic regions, the interactive media guidance application may build a database of demographic information for the users of different media and interactive media guidance application functions.

Once the interactive media guidance application has built a database of demographic information for media, the interactive media guidance application may use the database to identify demographic information for the users for which the interactive media guidance application does not have a demographic profile (e.g., users who selected not to provide demographic information during the initial setup). For example, the interactive media guidance application may retrieve (e.g., from database 417, FIG. 4) demographic information for the media and interactive media guidance application functions that an unknown user accesses, and associate that demographic information with the user. This may allow the interactive media guidance application to target users who have not supplied demographic information with media, advertisements, or other content that is targeted to the users who have provided demographic information and whose user profiles are similar.

The following example will illustrate this feature. The interactive media guidance application may determine that a first user is a 35-year-old male (e.g., from demographic information entered by the first user). The interactive media guidance application may further determine that the first user watches “Dukes of Hazzard.” The interactive media guidance application may then associate demographic metadata related to the demographic profile of the first user with “Dukes of Hazzard.” If the interactive media guidance application identifies a second user, who has not provided demographic information, but who watches “Dukes of Hazzard,” the interactive media guidance application may deduce that the second user most likely is a 35-year-old male. This deduction may be strengthened as the interactive media guidance application identifies additional media or interactive media guidance application functions that the second user has in common with other users who are part of the 35-year-old male demographic.

In some embodiments, the interactive media guidance application, the content source, or any other device of the interactive media system may perform may perform segmentation analysis on user profiles of a plurality of users against consumer psychographic information. Using this segmentation analysis, the interactive media guidance application may develop a number of generic demographic profiles (e.g., 20 profiles). Each day part may be associated with one or more generic demographic profiles based on the user profiles that are associated with the day parts. Each media or interactive media guidance application function may be associated with all of the relevant generic demographic profiles (e.g., the most common generic demographic profiles of the individual users that access the media or interactive media guidance application function. For example, “American Idol” will be associated with the “digerati,” “teenage girls” and “family household” profiles.

When new media is made available to the interactive media guidance application, the interactive media guidance application may monitor which users view the new media. For example, the interactive media guidance application may identify the day part at which the media is accessed (e.g., when a recorded program is viewed). Once the interactive media guidance application has identified the user or users that view the new media, the interactive media guidance application may associate the generic demographic profiles of those users to the new media. This may allow the interactive media guidance application to automatically make a determination of which users are accessing new media, without having to perform ongoing segmentation analysis or guessing about profiles.

In some embodiments, advertisements may be sold and targeted by demographic profile as determined by the day parting performed by the interactive media guidance application (e.g., implemented on a set-top box). For example, if the interactive media guidance application determines that a user of the “male college student” uses the user equipment during a particular day part (e.g., 12-1 AM), the interactive media guidance application may provide advertisements targeted specifically to that generic demographic profile. As another example, the interactive media guidance application may even provide advertisements targeted to the particular user's profile.

The interactive media guidance application may perform any suitable function once it has identified day parts and associated the day parts with users or user profiles. For example, the interactive media guidance application may display media, content, or interactive media guidance application features that are targeted or associated with a user or user profile (e.g., display a personalized user interface for the user or user profile associated with the current day part), sell or provide advertisements, or any other suitable function.

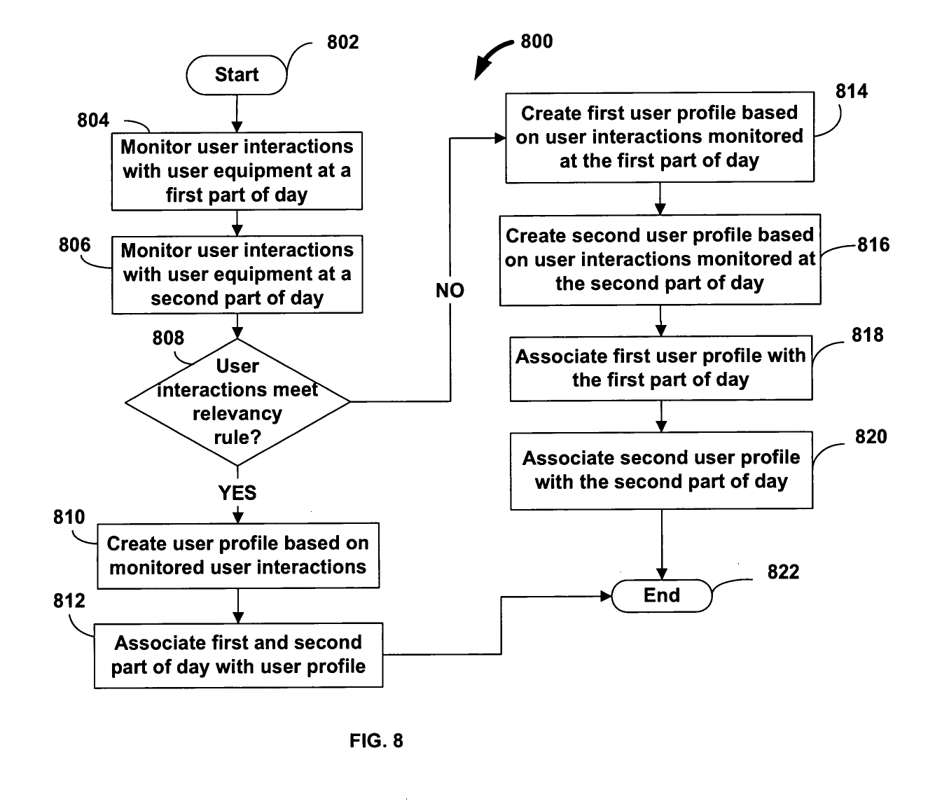

The following flow charts serves to illustrate processes involved in some embodiments of this invention. FIG. 8 is a flow chart of an illustrative process for automatically recognizing a user of an interactive media guidance application. Process 800 begins at step 802. At step 804, the interactive media guidance application monitors user interactions with the user equipment at a first part of day. For example, control circuitry 304 (FIG. 3) may monitor and log the times when users turn on and off the user equipment, the media or content that is viewed, and the interactive media guidance application features that are accessed. At step 806, the interactive media guidance application monitors user interactions with the user equipment at a second part of day. The first and second parts of day may be continuous, or may be separated in time. The interactive media guidance application may use any suitable criteria for determining when a day part begins or ends. For example, the interactive media guidance application may begin a day part when a user tunes to a channel and views the channel for a minimum amount of time (e.g., 5 minutes), and may end the day part when the program that the user is viewing ends. As another example, the interactive media guidance application may end the day part when the user tunes to another channel. As still another example, the interactive media guidance application may end the day part when the user begins to view a program or access an interactive media guidance application feature that is unrelated with the prior program (e.g., the user first views a cartoon, then changes channels to view a news broadcast). In some embodiments, the first and second day parts may be distributed over two days.

At step 808, the interactive media guidance application determines whether the user interactions monitored during the first and second day parts meet a relevancy rule. For example, the interactive media guidance application may identify metadata associated with the media accessed during the monitored user interactions (e.g., control circuitry 304 may receive the metadata for the media from database 417, FIG. 4), and determine whether the metadata is similar enough to satisfy the relevancy rule. The interactive media guidance application may measure the similarity of the accessed media in any suitable manner including, for example, calculating a distance between the accessed media (e.g., the aggregate relational distance), using an edge detection-type algorithm, or any other suitable manner. If the interactive media guidance application determines that the user interactions meet the relevancy rule, process 800 moves to step 810.

At step 810, the interactive media guidance application creates a user profile based on the user interactions monitored during the first and second day parts. For example, the interactive media guidance application may direct control circuitry 304 to store the media and interactive media guidance application functions accessed by the user during the first and second day parts in storage 308 (FIG. 3) as part of the user profile. At step 812, the interactive media guidance application associates the user profile created at step 810 with the first and second day parts. For example, the interactive media guidance application may direct control circuitry 304 to store the first and second day parts with the user profile in storage 308.

In some embodiments, the interactive media guidance application may associate a particular user with the user profile. For example, during one of the first and second day parts, the interactive media guidance application may prompt the user to identify himself (e.g., using a yes/no pop-up window such as that of screen 600, FIG. 6, or a pop-up window listing known users such as that of screen 700, FIG. 7). In response to the user identifying himself, the interactive media guidance application may associate the user profile with the identified user. Process 800 then ends at step 822.

If, at step 808, the interactive media guidance application instead determines that the monitored user interactions do not satisfy the relevancy rule, process 800 moves to step 814. At step 814, the interactive media guidance application creates a first user profile based on the user interactions monitored at the first day part. For example, the interactive media guidance application may direct control circuitry 304 to store the media and interactive media guidance application functions accessed by the user during the first day part in storage 308 (FIG. 3) as part of the first user profile.

At step 816, the interactive media guidance application creates a second user profile based on the user interactions monitored at the second day part. For example, the interactive media guidance application may direct control circuitry 304 to store the media and interactive media guidance application functions accessed by the user during the second day part in storage 308 (FIG. 3) as part of the second user profile.

At step 818, the interactive media guidance application associates the first user profile created at step 814 with the first day part. For example, the interactive media guidance application may direct control circuitry 304 to store the first day part with the first user profile in storage 308. At step 820, the interactive media guidance application associates the second user profile created at step 816 with the second day part. For example, the interactive media guidance application may direct control circuitry 304 to store the second day part with the second user profile in storage 308.

In some embodiments, the interactive media guidance application may associate particular users with each of the first and second user profiles. For example, during one of the first and second day parts, the interactive media guidance application may prompt the user to identify himself (e.g., using a yes/no pop-up window such as that of screen 600, FIG. 6, or a pop-up window listing known users such as that of screen 700, FIG. 7). In response to the user identifying himself, the interactive media guidance application may associate the user profile of the current day part (e.g., the first or second user profile) with the identified user. Process 800 then ends at step 822.

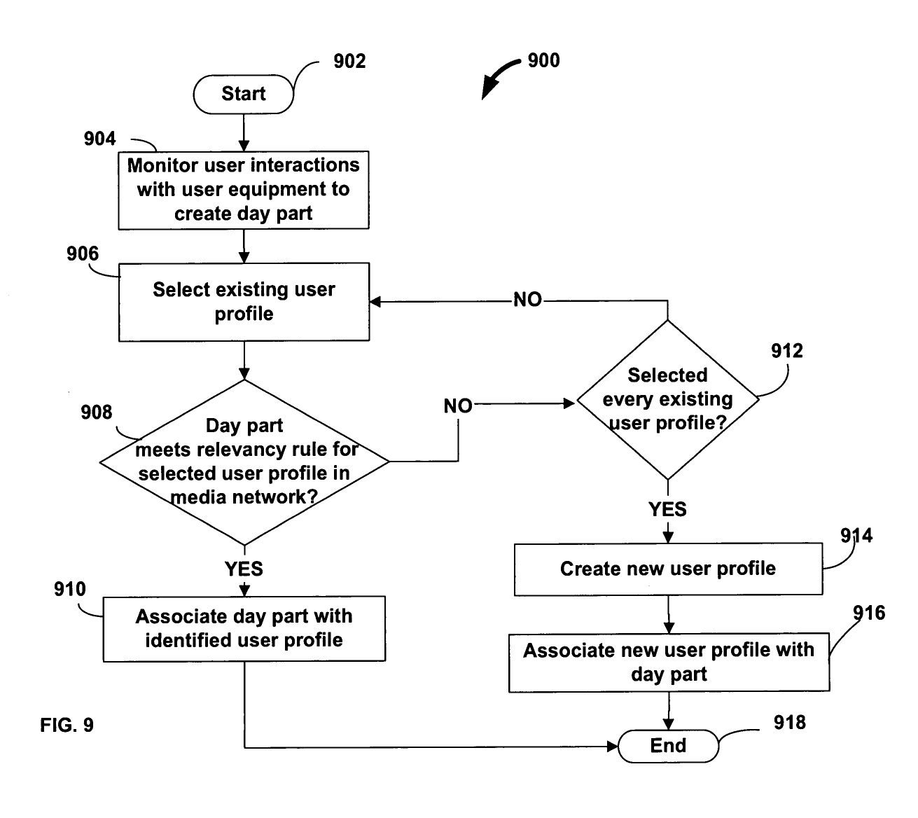

FIG. 9 is a flow chart of an illustrative process for associating a day part with a user profile. Process 900 starts at step 902. At step 904, the interactive media guidance application monitors user interactions with user equipment to create a day part. For example, control circuitry 304 (FIG. 3) may monitor and log the times when users turn on and off the user equipment, the media or content that is viewed, and the interactive media guidance application features that are accessed, and associate the monitored information with the day part. At step 906, the interactive media guidance application selects an existing user profile. For example, the interactive media guidance application may select a user profile stored in storage 308 (FIG. 3).

At step 908, the interactive media guidance application determines whether the day part created at step 904 meets a relevancy rule for the user profile selected at step 906. For example, the interactive media guidance application may identify metadata associated with the day part and with the user profile (e.g., control circuitry 304 may receive the metadata for the media from database 417, FIG. 4), and determine whether the metadata is similar enough to satisfy the relevancy rule. The interactive media guidance application may measure the similarity of the user profile and day part in any suitable manner including, for example, calculating a distance between the day part and the user profile (e.g., the aggregate relational distance), using an edge detection-type algorithm, or any other suitable manner. If the interactive media guidance application determines that the day part and the selected user profile meet the relevancy rule, process 900 moves to step 910.

At step 910, the interactive media guidance application associates the day part with the identified user profile. For example, the interactive media guidance application may direct control circuitry 304 to store the day parts with the user profile in storage 308. Process 900 then moves to step 918 and ends.

If, at step 908, the interactive media guidance application instead determines that the day part and the selected user profile do not meet the relevancy rule, process 900 moves to step 912. At step 912, the interactive media guidance application determines whether it has selected every existing user profile. For example, control circuitry 304 may determine whether there are other user profiles stored in memory 308 that the control circuitry has not compared to the day part. If the interactive media guidance application determines that every existing user profile has not been selected, process 900 moves to step 906 and selects a user profile that has not yet been selected.

If, at step 912, the interactive media guidance application instead determines that the user profile has selected every existing user profile, process 900 moves to step 914. At step 914, the interactive media guidance application creates a new user profile. For example, the interactive media guidance application may direct control circuitry 304 to store the media and interactive media guidance application functions accessed by the user during the day part in storage 308 (FIG. 3) as part of a new user profile. At step 916, the interactive media guidance application associates the new user profile with the day part. For example, the interactive media guidance application may direct control circuitry 304 to store the day part with the user profile in storage 308. Process 900 then moves to step 918 and ends.

One skilled in the art will appreciate that the invention can be practiced by other than the prescribed embodiments, which are presented for purposes of illustration and not of limitation, and the invention is limited only by the claims which follow.

What is claimed is:

1. A method for automatically recognizing a user of an interactive media guidance application implemented on user equipment, comprising:
monitoring user interactions with the interactive media guidance application during a first part of day;
monitoring user interactions with the interactive media guidance application during a second part of day;
determining whether the user interactions of the first and second parts of day meet a relevancy rule; and
in response to determining that the user interactions of the first and second parts of day meet the relevancy rule, associating the two parts of day with a user profile.

2. The method defined in claim 1 wherein:
monitoring user interactions during the first and second parts of day comprises monitoring programs watched on the user equipment; and
determining whether the user interactions of the first and second parts of day meet the relevancy rule comprises determining whether the programs watched during the first and second parts of day meet the relevancy rule.

3. The method defined in claim 1 wherein determining whether the user interactions of the first and second parts of day meet the relevancy rule comprises determining the similarity between the user interactions of the first and second parts of day.

4. The method defined in claim 3 wherein determining the similarity between the user interactions of the first and second parts of day comprises determining the similarity between metadata associated with the user interactions of the first and second parts of day.

5. The method defined in claim 2 wherein determining whether the programs watched during the first and second parts of day meet the relevancy rule comprises:
for each program, retrieving media guidance data defining at least one property of the program; and
determining whether an aggregate relational distance between a property of each of the programs meets a relevancy threshold.

6. The method defined in claim 5 wherein the aggregate relational distance is a measure of the similarity between the respective properties of the programs.

7. The method defined in claim 1 further comprising:
receiving an express indication of the user's identity that associates the user with the first part of day;
receiving express media preference designations from the user; and
while the user is not expressly identified with the second part of day, performing a media guidance function targeted to the user during the second part of day based on the express media preference designations.

8. The method defined in claim 7 further comprising during the second part of day, prompting the user to confirm whether the user is the user associated with the first part of day.

9. The method defined in claim 1 further comprising:
monitoring user interactions with the interactive media guidance application during a third part of day;
determining whether the user interactions of the third part of day meet the relevancy rule; and
in response to determining that the user interactions of the third part of day do not meet the relevancy rule, associating the third part of day with a user profile that is different from the user profile of the first and second parts of day.

10. The method defined in claim 1 wherein the user profile is used for the first and second parts of day across multiple days.

11. The method defined in claim 1 further comprising performing a media guidance function targeted to the user during the second part of day based on the user profile.

12. The method defined in claim 1 further comprising:
selecting a demographic from among a plurality of demographics based on the user profile; and
performing a media guidance function targeted to the user during the second part of day based on the demographic.

13. The method defined in claim 1 wherein:
the user equipment comprises a set-top box; and
the interactive media guidance application is an interactive television program guide implemented on the set-top box.

14. A method for automatically recognizing a user of an interactive media guidance application implemented on user equipment, comprising:
monitoring user interactions with the interactive media guidance application during a first part of day;
monitoring user interactions with the interactive media guidance application during a second part of day;
identifying a first user profile from the user interactions of the first part of day;
identifying a second user profile from the user interactions of the second part of day; and
associating the first part of day with the first user profile and the second part of day with the second user profile.

15. The method defined in claim 14 wherein:
the method further comprises determining whether the first and second user profiles meet a relevancy rule; and
associating the first part of day with the first user profile and the second part of day with the second user profile is performed in response to determining that the first and second user profiles do not meet the relevancy rule.

16. The method defined in claim 14 wherein:
the method further comprises determining that the user interactions of the first and second parts of day do not meet a relevancy rule; and
associating the first part of day with the first user profile and the second part of day with the second user profile is performed in response to determining that the user interactions of the first and second parts of day do not meet the relevancy rule.

17. The method defined in claim 16 wherein determining whether the user interactions of the first and second day parts meet the relevancy rule comprises determining the similarity between the user interactions of the first and second day parts.

18. The method defined in claim 14 wherein:
monitoring user interactions during the first and second parts of day comprises monitoring programs watched on the user equipment; and
the method further comprises determining whether the programs watched during the first and second parts of day meet a relevancy rule.

19. The method defined in claim 18 wherein determining whether the programs watched during the first and second parts of day meet the relevancy rule comprises:
for each program, retrieving media guidance data defining at least one property of the program; and
determining whether an aggregate relational distance between a property of each of the programs meets a relevancy threshold.

20. The method defined in claim 18 wherein the aggregate relational distance is a measure of the similarity between the respective properties of the programs.

21. The method defined in claim 14 wherein:
the user equipment comprises a set-top box; and
the interactive media guidance application is an interactive television program guide implemented on the set-top box.

22. A system for automatically recognizing a user of an interactive media guidance application implemented on user equipment comprising a display device and control circuitry, the control circuitry configured to:
monitor user interactions with the interactive media guidance application during a first part of day;
monitor user interactions with the interactive media guidance application during a second part of day;
determine whether the user interactions of the first and second parts of day meet a relevancy rule; and
in response to determining that the user interactions of the first and second parts of day meet the relevancy rule, associate the two parts of day with a user profile.

23. The system defined in claim 22 wherein the control circuitry is further configured to:
monitor programs watched on the user equipment; and
determine whether the programs watched during the first and second parts of day meet the relevancy rule.

24. The system defined in claim 22 wherein the control circuitry is further configured to determine the similarity between the user interactions of the first and second parts of day.

25. The system defined in claim 24 wherein the control circuitry is further configured to determine the similarity between metadata associated with the user interactions of the first and second parts of day.

26. The system defined in claim 23 wherein the control circuitry is further configured to:
for each program, retrieve media guidance data defining at least one property of the program; and
determine whether an aggregate relational distance between a property of each of the programs meets a relevancy threshold.

27. The system defined in claim 26 wherein the aggregate relational distance is a measure of the similarity between the respective properties of the programs.

28. The system defined in claim 22 wherein the control circuitry is further configured to:
receive an express indication of the user's identity that associates the user with the first part of day;
receive express media preference designations from the user; and
while the user is not expressly identified with the second part of day, perform a media guidance function targeted to the user during the second part of day based on the express media preference designations.

29. The system defined in claim 28 wherein the control circuitry is further configured to, during the second part of day, prompt the user to confirm whether the user is the user associated with the first part of day.

30. The system defined in claim 22 wherein the control circuitry is further configured to:
monitor user interactions with the interactive media guidance application during a third part of day;
determine whether the user interactions of the third part of day meet the relevancy rule; and
in response to determining that the user interactions of the third part of day do not meet the relevancy rule, associate the third part of day with a user profile that is different from the user profile of the first and second parts of day.

31. The system defined in claim 22 wherein the user profile is used for the first and second parts of day across multiple days.

32. The system defined in claim 22 wherein the control circuitry is further configured to perform a media guidance function targeted to the user during the second part of day based on the user profile.

33. The system defined in claim 22 wherein the control circuitry is further configured to:
select a demographic from among a plurality of demographics based on the user profile; and
perform a media guidance function targeted to the user during the second part of day based on the demographic.

34. The system defined in claim 22 wherein:
the user equipment comprises a set-top box; and
the interactive media guidance application is an interactive television program guide implemented on the set-top box.

35. A system for automatically recognizing a user of an interactive media guidance application implemented on user equipment comprising a display device and control circuitry, the control circuitry configured to:
monitor user interactions with the interactive media guidance application during a first part of day;
monitor user interactions with the interactive media guidance application during a second part of day;
identify a first user profile from the user interactions of the first part of day;
identify a second user profile from the user interactions of the second part of day; and
associate the first part of day with the first user profile and the second part of day with the second user profile.

36. The system defined in claim 35 wherein the control circuitry is further configured to:
determine whether the first and second user profiles meet a relevancy rule; and
associate the first part of day with the first user profile and the second part of day with the second user profile is performed in response to determining that the first and second user profiles do not meet the relevancy rule.

37. The system defined in claim 35 wherein the control circuitry is further configured to:
determine that the user interactions of the first and second parts of day do not meet a relevancy rule; and
associate the first part of day with the first user profile and the second part of day with the second user profile is performed in response to determining that the user interactions of the first and second parts of day do not meet the relevancy rule.

38. The system defined in claim 37 wherein the control circuitry is further configured to determine the similarity between the user interactions of the first and second day parts.

39. The system defined in claim 35 wherein the control circuitry is further configured to:
monitor user interactions during the first and second parts of day comprises monitoring programs watched on the user equipment; and
determine whether the programs watched during the first and second parts of day meet a relevancy rule.

40. The system defined in claim 39 wherein the control circuitry is further configured to:
for each program, retrieve media guidance data defining at least one property of the program; and
determine whether an aggregate relational distance between a property of each of the programs meets a relevancy threshold.

41. The system defined in claim 39 wherein the aggregate relational distance is a measure of the similarity between the respective properties of the programs.

42. The system defined in claim 35 wherein:
the user equipment comprises a set-top box; and
the interactive media guidance application is an interactive television program guide implemented on the set-top box.
